(19) United States
(12) Patent Application Publication
(10) Pub. No.: US 2008/0019680 A1
(43) Pub. Date: Jan. 24, 2008

(54) Imaging device and image acquiring method

(75) Inventors: Hirokazu Kasahara, Okaya-shi (JP); Mutsuto Tezuka, Shiojiri-shi (JP); Takashige Tanaka, Matsumoto-shi (JP); Kenji Fukasawa, Matsumoto-shi (JP); Michihiro Nagaishi, Okaya-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/728,005

(22) Filed: Mar. 22, 2007

(30) Foreign Application Priority Data
Mar. 22, 2006 (JP) 2006-078988

(51) Int. Cl. G03B 17/00

(52) U.S. Cl. 396/48

(57) ABSTRACT

Provided is an imaging device including a photographing instruction input unit which inputs a photographing instruction, a mode setting unit which sets a plurality of photographing modes including substantially the same amount of exposure and different aperture and a photographing unit which performs continuously a photographing process using the plurality of photographing modes in accordance with the photographing instruction.

### BACKGROUND

1. Technical Field

The present invention relates to an imaging device and a method of acquiring a plurality of images.

2. Related Art

A camera having a photographing function of exposure bracketing having slightly differing exposure times so as to take a plurality of photographs is widely known (e.g., JP-A-5-303130). In addition, a camera having a photographing function of focus bracketing which varies a focusing state by degrees and a photographing function of flash bracketing which varies the strength of a flash by degrees is known. In addition, other than the photographing function of exposure bracketing, a digital camera having a photographing function of white balance bracketing which varies white balance (color temperature) and a photographing function of sensitivity bracketing which varies the sensitivity of an imaging element is known (e.g., JP-A-7-318785).

Herein, in the case of a silver salt camera or a digital camera, photography technology which varies the depth of field is known. For example, by slightly opening an aperture, when a photo is taken by narrowing the depth of field, an image which blurs a background may be obtained. On the contrary, by narrowing slightly the diaphragm, when a photograph is taken by increasing the depth of field, an image may be obtained in which an object disposed close to a camera, an object disposed far from the camera, and all objects therebetween are in focus.

Other examples of such an imaging device are disclosed in JP-A-2000-75371, JP-A-2003-101869, and JP-A-2005-173169.

However, a user who is not accustomed to using cameras may not be familiar with camera functions for adjusting the aperture so as to vary the depth of field. In addition, it is very difficult for such a user who is not accustomed to using cameras to appropriately set the depth of field so as to freely adjust the degree of a blur mode of an image.

### SUMMARY

An advantage of some aspects of the invention is that it provides a photography technology with which the depth of field can be easily varied.

According to an aspect of the invention, there is provided an imaging device including a photographing instruction input unit configured to enable inputting of a photographing instruction, a mode setting unit which sets a plurality of photographing modes having substantially the same amount of exposure and different apertures, and a photographing unit which successively performs photographing processes using the plurality of photographing modes in response to a single photographing instruction.

According to the first aspect of the invention, the user acquires easily a plurality of images having substantially the same amount of exposure and different depth of fields. The user uses easily a photographing technology varying the depth of field.

The imaging device may further include an automatic exposure adjusting unit and an allowable setting range of apertures in the plurality of photographing modes may be a range where an appropriate amount of exposure can be set by the automatic exposure adjusting unit. The allowable setting range of apertures in the plurality of photographing modes may be a range where the appropriate amount of exposure can be set with a shutter speed for a condition in which motion blur does not occur. Accordingly, degradation of the pixel generated by motion blur may be prevented to the continuous photographed image.

The plurality of photographing modes may include a first photographing mode of which the aperture is set to an open limit of the allowable setting range and a second photographing mode in which the aperture can be set to a contraction limit of the allowable setting range. Accordingly, the user easily acquires two images having high depth of field.

The plurality of photographing modes may include all the photographing modes which can be set within the allowable setting range. Accordingly, the user acquires a plurality of images sequentially in the allowable range varying the depth of field.

The imaging pickup device may further include an image sensor, the sensitivity of which can be varied by a plurality of levels, and the plurality of photographing modes include a plurality of photographing modes having substantially the same amount of exposure with the various sensitivity levels of the image sensor. Accordingly, the aperture is varied in a broad range by maintaining the exposure is substantially the same. As a result, the user acquires the plurality of images varying substantially the depth of field.

The imaging pickup device may further include an edge detecting section which detects an edge portion of a first image among a plurality of images photographed using the plurality of photographing modes, a difference calculating section which calculates differences between color components of the edge portion of the first image and the color components of the edge portion of a second image photographed using the photographing mode in which the aperture is narrower than that of the first image among the plurality of images, and a determining section which determines whether a color blur occurs in the first image on the basis of the differences. Accordingly, it is possible to determine whether a plurality of images photographed continuously includes the color blur.

The detection of the edge portion of the first image may be performed by detecting an edge portion which is common to the plurality of images. The edge portion which is common to the plurality of images may be an edge portion of an image photographed using a photographing mode in which the aperture is opened to the maximum extent possible among the plurality of images. Accordingly, since the detection of the edge portion which is determined does not be performed, the processing time and the process load may be reduced.

The second image may be an image photographed using the photographing mode in which the aperture is narrowed to the maximum. Accordingly, since the color blur determining process is performed by the image which does not have the color blue as a standard, the color blur determining process is performed with precision.

The imaging device may further include a filter processing section which performs a filtering process in which a human visual filter is applied to the edge portion of the first image and the second image. Here, the difference calculating section may calculate the differences between the edge portions having been subjected to the filtering process. Accordingly, since the color blur determining process is performed by considering the human visual characteristic, the color blur determining process is properly performed.

The first image which is determined to have color blur may be deleted. Accordingly, the user acquires the desirable images having no color blur among the continuous photographed images.

Information indicating an occurrence of color blur may be correlated with the first image which is determined to have the color blur. Accordingly, the user or the device acquiring the image may be easily recognizes the color blur determining process about the continuous photographed images.

Only the image photographed using the photographing mode in which the aperture is opened to the maximum extent possible may be stored among the second image and the first image which is determined to have no color blur. Accordingly, an image having substantially different depth of fields in the range having no color blur may be easily obtained.

The invention can be embodied in various embodiments. In addition to the above-mentioned imaging device, the invention may be embodied as a method used for acquiring the plurality of images. Further, the invention may be embodied as a computer program for realizing this device or method, a recording medium having the computer program recorded thereon, data signals embodied in a carrier wave with the computer program, and the like.

### BRIEF DESCRIPTION OF THE DRAWINGS

The invention will be described with reference to the accompanying drawings, wherein like numbers reference like elements.

FIG. 1 is a schematic view illustrating an imaging device of a digital camera according to a first embodiment.

FIG. 2 is an operation flow chart of the digital camera in a bracket mode of a depth of field.

FIG. 3 is a flow chart illustrating a detection process of an aperture limit.

FIG. 4 is a diagram illustrating photographing modes in the bracket mode of the depth of field.

FIG. 5 is an embodiment illustrating a photographed image by using the bracket mode of the depth of field.

FIG. 6 is a flow chart illustrating a process routine of a color blur determining process.

FIG. 7 is an embodiment of a Laplacian filter used for an edge detection.

FIG. 8 is a schematic view of a system according to a second embodiment.

FIG. 9 is a flowchart illustrating an operation of the digital camera according to the second embodiment.

FIG. 10 is a flowchart illustrating an operation of a personal computer according to the second embodiment.

FIG. 11 is a flowchart illustrating an operation of the digital camera according to a first modified example.

FIG. 12 is a flowchart illustrating an operation of the digital camera according to a second modified example.

FIG. 13 is a program line diagram illustrating photographing mode stored to a photographing mode setting unit.

### DESCRIPTION OF EXEMPLARY EMBODIMENTS

### A. First Embodiment

Configuration of Device

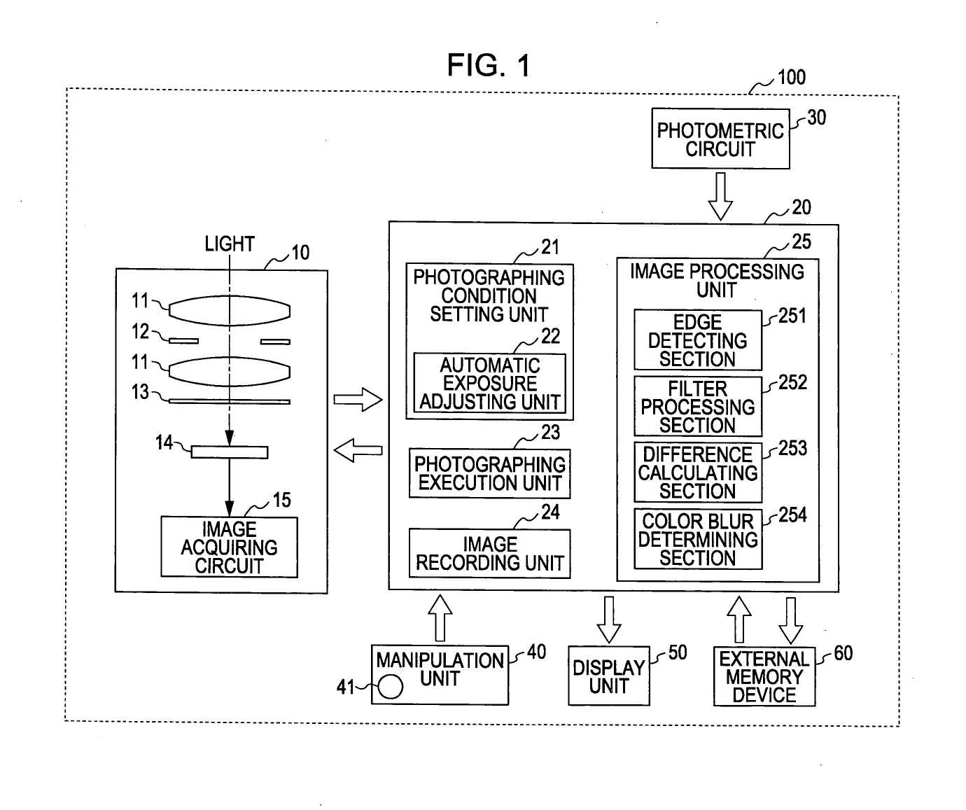

Next, an embodiment of an invention will be described. FIG. 1 is a schematic view illustrating a digital camera as an imaging device according to a first embodiment.

A digital camera 100 includes a photographing unit 10, a control unit 20, a photometric circuit 30 which measures the brightness of a subject, a manipulation unit 40, a display unit 50 such as a liquid crystal, and an external memory device 60.

The photographing unit 10 actually photographs and outputs image data generated after photographing to a control unit 20. The photographing unit 10 includes a lens 11, a diaphragm mechanism 12, a shutter 13, an image sensor 14, and an image acquiring circuit 15. The lens 11 collects light from the subject to a light-receiving surface of the image sensor 14 so as to form an image of the subject on the light-receiving surface of the image sensor 14. The diaphragm mechanism 12 is a mechanism which adjusts the amount of light passing through the lens. The shutter 13 is a mechanism which is used to adjust the amount of time (exposure time) the light-receiving surface of the image sensor 14 is exposed to light from the subject. The image sensor 14 converts the brightness of an image of a focused subject into an electric signal. For example, a CCD (Charge Coupled Device) or a CMOS (Complementary Metal-Oxide Semiconductor) is used for the image sensor 14. The image acquiring circuit 15 includes an A/D converter, converts an electric signal outputted by the image sensor 14, and generates an image data showing an image focused on the light-receiving surface of the image sensor 14.

The control unit 20 is a well-known computer which includes an internal memory device such as a CPU, ROM, OR RAM. The control unit 20 executes a control program so as to realize various functions for controlling parts of the digital camera 100. In FIG. 1, functional parts which are necessary to explain the embodiment are selectively denoted among the functional parts controlled by the control unit 20. The control unit 20 includes a photographing mode setting unit 21, a photographing execution unit 23, an image recording unit 24, and an image processing section 25. The photographing mode setting unit 21 sets various photographing modes, for example, a shutter speed (exposure time), a contraction value, with or without emitting the light of a flash, and the sensitivity of the image sensor 14. The photographing mode setting unit 21, on the basis of the brightness of a subject measured by the photometric circuit 30, includes an automatic exposure adjusting unit 22 for setting an appropriate amount of exposure. The photographing mode setting unit 21 uses the automatic exposure adjusting unit 22 so as to set the photographing modes. The photographing execution unit 23 controls the photographing unit 10 and operates the photographing unit 10 by using the photographing modes which have been set by the photographing mode setting unit 21. The image recording unit 24 stores image data to be processed an image processing section 25 in the external memory device 60.

The image processing unit 25 performs various image processes on the image data outputted from the photographing unit 10. FIG. 1 shows a function which is necessary for the process (perform color blur determining process) of determining a color blur of an image among the functions of the image processing unit 25. The image processing unit 25 includes an edge detecting section 251, a filter processing section 252, a difference calculating section 253, and a color blur determining section 254. The function units of the image processing unit 25 will be described hereinafter.

The manipulation unit 40 includes control buttons so as to input requirements from a user and transfers the inputted requirements to the control unit 20. The manipulation unit 40, includes a shutter button 41 which is a photographing instruction input unit so as to input a photographing instruction. The manipulation unit 40 also includes various manipulation buttons such as a selection button for a photographing mode (not shown).

An external memory device 60, as a memory device for storing a created image data, may be a mountable recording medium such as a memory card or an external HDD (hard disk drive). The image data, with accessory information related to the image data, is stored in an image file according to a predetermined format and is saved in the external memory device 60. Regarding the format of the image file, for example, an image file format (Exif) for a digital camera is used. The image data, for example, is stored in the image file in a storage format such as JPEG, TIFF, GIF, or BMP.

Operation of Digital Camera 100

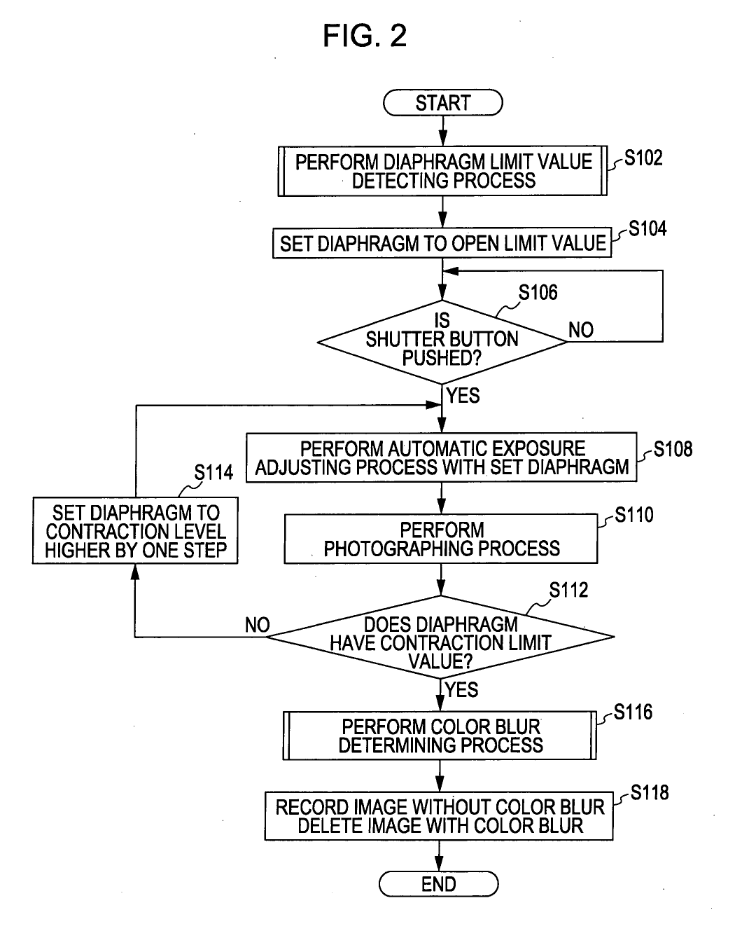

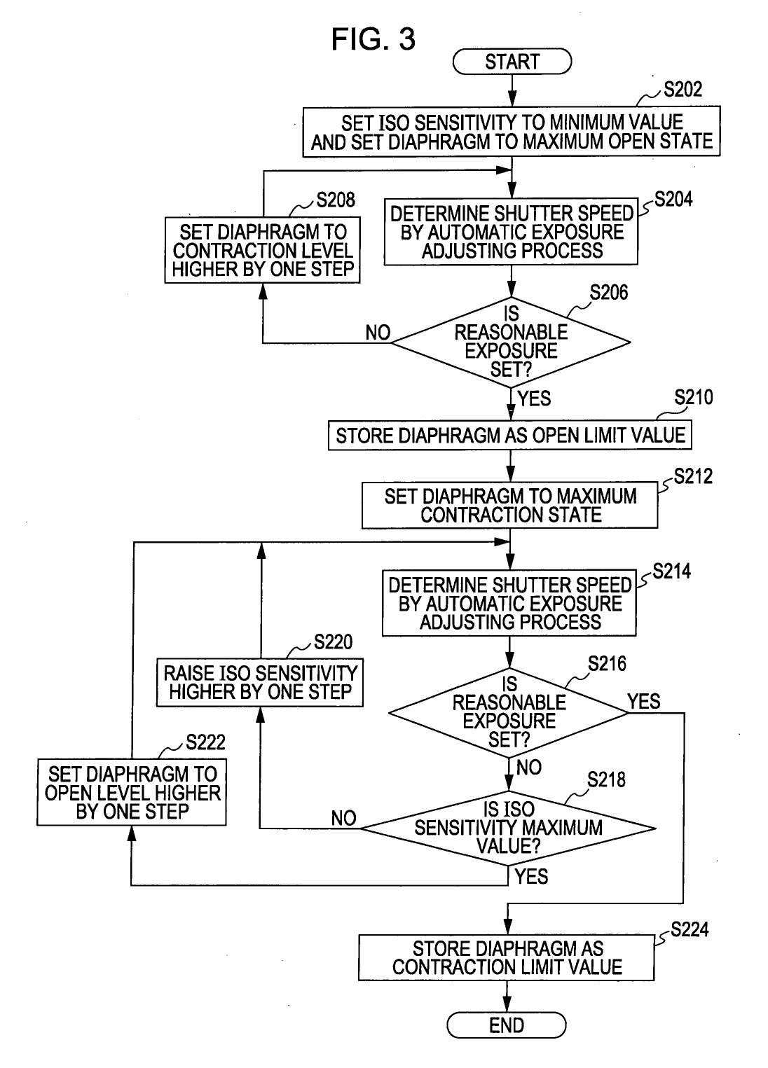

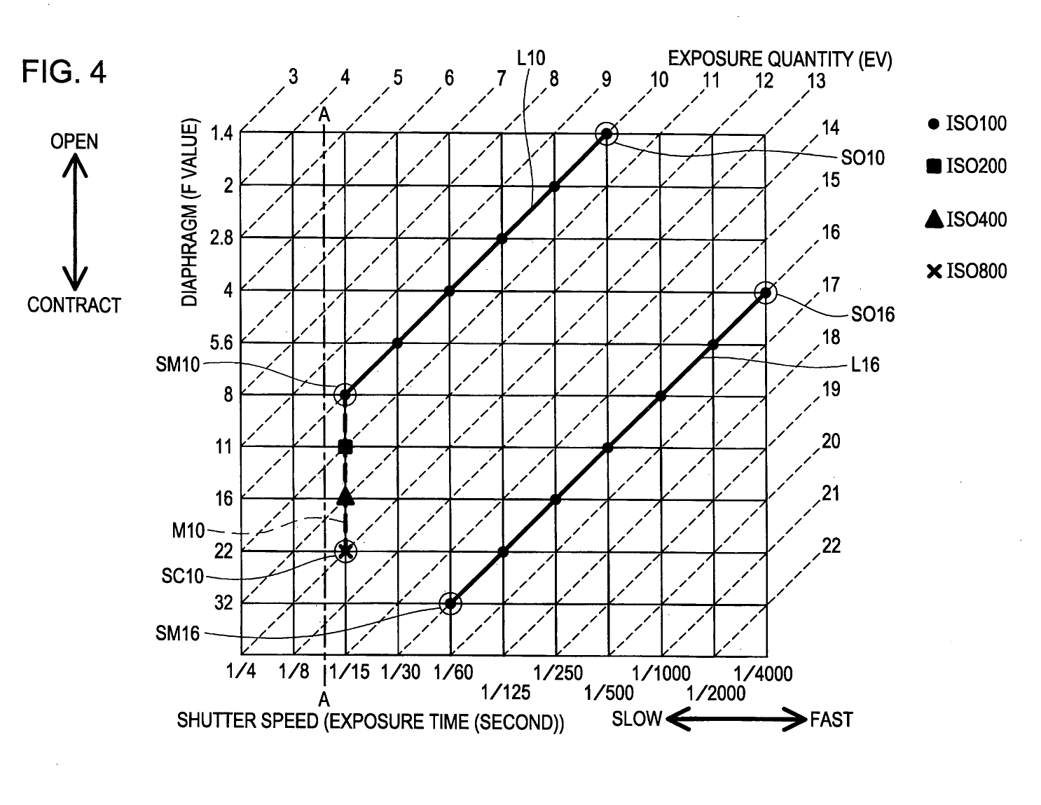

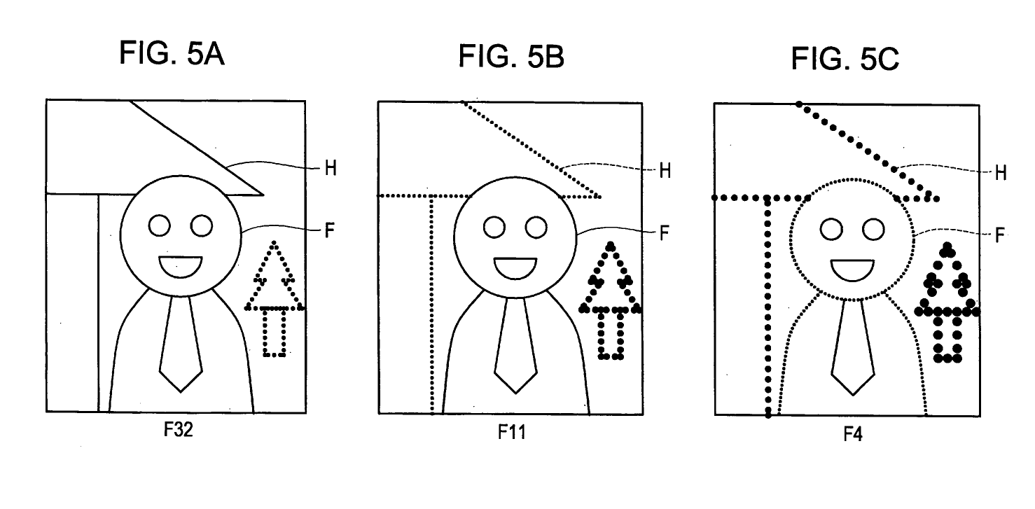

With reference to FIGS. 2 to 5, an operation of the digital camera 100 will be described for a depth of field bracket mode. FIG. 2 is a flow chart illustrating the operation of the digital camera 100 in the depth of field bracket mode. FIG. 3 is a flow chart illustrating a process routine where the aperture limit is detected. FIG. 4 is a diagram illustrating photographing modes in the depth of field bracket mode. FIG. 5 illustrates an image obtained by using the depth of field bracket mode.

When the user controls the manipulation unit 40 and selects the bracket mode of the depth of field, the aperture limit detecting process is performed by the photographing mode setting unit 21 of the control unit 20 (step s102). The detecting process for the aperture limit, for example, may be performed when the user pushes the shutter button 41 so as to be in a half-pushed state. The detecting process for the aperture limit may be repeatedly performed about the subject captured by the digital camera 100, when the digital camera 100 is in a state where the photographing process is performed.

When the aperture limit detecting process is performed, the photographing mode setting unit 21 sets an ISO sensitivity to a minimum value and sets the aperture to a maximum extent possible. The ISO sensitivity as a value showing the sensitivity of a film, in the digital camera, is a value showing the sensitivity of the image sensor 14. The digital camera 100 in the embodiment can have the ISO sensitivity set to four levels of 100, 200, 400, and 800. If a digital camera has a high ISO sensitivity, it means the sensitivity of the image sensor 14 of the camera is high. The ISO sensitivity is set to 100 which is a minimum value. The state of the diaphragm mechanism 12 may be indicated by a F number. The digital camera 100 in the embodiment has the F numbers values of 1.4, 2, 2.8, 4, 5.6, 8, 11, 16, 22, and 32. Hereinafter, “the diaphragm mechanism 12 sets the F number to 1.4” is expressed as “the diaphragm is set to F1.4.” The lowest F number value corresponds to the open limit of the aperture and the highest F number corresponds to the contraction limit of the aperture. When the diaphragm is set to a contraction level higher by one step, for example, the diaphragm is set from F1.4 to F2, exposure is reduced by half. The diaphragm is set to the maximum open state of F1.4.

Subsequently, the automatic exposure adjusting unit 22 of the photographing mode setting unit 21 fixes the ISO sensitivity set by the above-mentioned step and the F number so as to perform automatic exposure adjustment, thereby determining the shutter speed (step s204). Specifically, the automatic exposure adjusting unit 22 measures the brightness of the subject by using the photometric circuit 30 and an appropriate amount of exposure is calculated in accordance with the brightness of the subject. The appropriate amount of exposure is indicated by using an EV (Exposure Value). If the subject has a high brightness, the corresponding exposure value will be high. The automatic exposure adjusting unit 22 determines the shutter speed so that an appropriate calculated amount of exposure is obtained. The shutter speed is indicated by an exposure time (seconds). In the embodiment, the shutter speed of the digital camera 100 is set at any of eleven levels from a high shutter speed of 1/4000 sec fast to a low shutter speed of ¼ sec slow, as shown in the horizontal axis. When the shutter speed is set higher by one step, for example, the shutter speed increases from 1/30 sec to 1/60 sec. Accordingly, the exposure quantity is reduced by half. In FIG. 4, the relationship between the exposure quantity (EV), the aperture (F number value), and the shutter speed (exposure time) is shown. When the ISO sensitivity is 100, a combination of aperture having an exposure quantity of 10 EV and the shutter speed, as shown in FIG. 4, is depicted as a bold dotted line L10. Accordingly, when the appropriate amount of exposure is 10 EV, the diaphragm is F1.4, and the ISO sensitivity is 100, the automatic exposure adjusting unit 22 determines that the shutter speed is 1/500 (FIG. 4: see a dot S010 on the bold dotted line L10). Meanwhile, when the ISO sensitivity is 100, the combination of the aperture having 16 EV and the shutter speed is depicted a broad bold line L16 as shown in FIG. 4. Accordingly, when the appropriate amount of exposure is 16 EV, the diaphragm is F1.4, and the ISO sensitivity is 100, the appropriate shutter speed is higher than 1/4000 (exposure time is short). Accordingly, the automatic exposure adjusting unit 22 does not determine the shutter speed.

Subsequently, the photographing mode setting unit 21 determines whether an appropriate amount of exposure may be set (step s206). The photographing mode setting unit 21 determines that an appropriate amount of exposure can be set, when the shutter speed is determined so that the appropriate amount of exposure is set in the above-mentioned step. The photographing mode setting unit 21 determines that an appropriate amount of exposure cannot be set, when the shutter speed is not determined.

If the photographing mode setting unit 21 determines that an appropriate amount of exposure cannot be set (step s206: No), the diaphragm is set to a contraction level higher by one step from the current state (step S208). For example, when the current diaphragm is set to F1.4, the diaphragm is newly set to F2. When the photographing mode setting unit 21 changes the aperture, referring back to step 204, the shutter speed is determined again on the basis of the diaphragm newly set.

On the other hand, when the photographing mode setting unit 21 determines that an appropriate amount of exposure is set (step s206: YES), the current diaphragm is stored as an open limit (step s210). For example, when the appropriate amount of exposure is 10 EV, the open limit is set to F1.4 (FIG. 4: referring to a dot S010 on a bold dotted line L10). In addition, when the appropriate amount of exposure is 16 EV, the open limit is set to F4 (FIG. 4: referring to a dot S016 on the bold line L16).

Subsequently, the photographing mode setting unit 21 sets the diaphragm to a maximum contraction extent possible (step s212). In the digital camera 100 of the embodiment, the diaphragm is set to F32. The automatic exposure adjusting unit 22 fixes the ISO sensitivity and the F number value so as to perform automatic exposure adjustment, similarly to step s204, thereby determining the shutter speed (step s214). The shutter speed is determined for a condition in which motion blur does not occur. In FIG. 4, a dotted dashed line A-A shows an example in which motion blur occurs. That is, in the embodiment, the digital camera 100 determines that a negative effect of motion blur occurs when the shutter speed is lower than ⅛. Accordingly, the automatic exposure adjusting unit 22 sets the shutter speed to 1/15 or sets the shutter speed higher than 1/15. The automatic exposure adjusting unit 22 sets the shutter speed to 1/60 (FIG. 4: referring to a dot SC16 on the bold dotted line L16), when the appropriate amount of exposure is 16 EV, the diaphragm is set to F32, and the ISO sensitivity is 100. On the other hand, when the appropriate amount of exposure is 10 EV, the diaphragm is F32, and the ISO sensitivity is 100, the appropriate shutter speed is set lower than 1/15 (exposure time is long). Accordingly, the automatic adjusting unit 22 does not determine the shutter speed.

Subsequently, the photographing mode setting unit 21 determines that an appropriate amount of exposure may be set (step s216). The photographing mode setting unit 21 determines that an appropriate amount of exposure can be set, when the shutter speed is determined so that the appropriate amount of exposure is set in the above-mentioned step. The photographing mode setting unit 21 determines that an appropriate amount of exposure cannot be set, when the shutter speed is not determined.

When the photographing mode setting unit 21 determines that the appropriate amount of exposure has not been set (step s216: NO), the photographing mode setting unit 21 determines whether the current ISO sensitivity has been set at the maximum value (in the embodiment, 800) (step s218). When the photographing mode setting unit 21 determines that the ISO sensitivity has not been set at the maximum value (step s218: No), the ISO sensitivity is increased by one step (step s220). Meanwhile, when the photographing mode setting unit 21 determines that the ISO sensitivity has been set at the maximum value (step s218: YES), the photographing mode setting unit 21 increases the opening of the diaphragm by one step (step s222). For example, when the current diaphragm is newly set to F1.4, the diaphragm is set to F2. When the ISO sensitivity or the diaphragm is changed, the photographing mode setting unit 21, referring back to step s214, determines the shutter speed again with the newly set diaphragm or the newly set ISO sensitivity.

On the other hand, when the photographing mode setting unit 21 determines that an appropriate amount of exposure can be set (step s216: YES), the current aperture is stored as a contraction limit (step s224). For example, when the appropriate amount of exposure is 10 EV, F22 is the contraction limit (FIG. 4: referring to a dot SC10 on a dotted line M10). In addition, when the appropriate amount of exposure is 16 EV, F32 is the contraction limit (FIG. 4: referring to a dot SC 16 on the bold dotted line L16). Likewise, when the open limit of the diaphragm and the contraction limit extent possible are stored, the aperture limit determining process ends.

Referring to FIG. 3, when the aperture limit detecting process ends, the photographing mode setting unit 21 sets the diaphragm to a stored open limit in the aperture limit detecting process and then waits for the photographing instruction from the user (step s104). When the user presses the shutter button 41 and inputs the photographing instruction (step s106: YES), the automatic exposure adjusting unit 22 performs automatic exposure adjustment on the basis of the set aperture (step s108). Accordingly, the ISO sensitivity and the shutter speed are determined and so that an appropriate exposure can be obtained on the basis of the set aperture. When the automatic exposure adjustment is performed, the photographing execution unit 23 enables the photographing unit 10 to operate with the determined photographing modes (the aperture, the ISO sensitivity, the shutter speed). When the photographing process ends, the photographing mode setting unit 21 determines whether the current aperture is the contraction limit stored by the aperture limit detecting process (step s112). When the photographing mode setting unit 21 determines that the aperture does not be set to the contraction limit (step s112: No), the photographing mode setting unit 21 sets the aperture to the contraction level higher by one step (step s114). When the aperture is varied, referring back to step s108, a following photographing process is performed. On the other hand, when the photographing mode setting unit 21 determines that the aperture is set to the contraction limit (step s112: YES), the photographing mode setting unit 21 terminates the photographing process and performs a color blur determining process (step s116).

Likewise, the aperture varies sequentially from the open limit to the contraction limit and the photographing process is continuously performed. Accordingly, the control unit 20 as digital data obtains a plurality of images in which the subject and the amount of exposure are substantially the same and the depth of field is sequentially varied. For example, when the subject having the appropriate amount of exposure of 16 EV is photographed, seven photographing processes are continuously performed by using the photographing modes corresponding to seven dots on the bold dotted line L16 shown in FIG. 4. As a result, the control unit 20 obtains digital data of seven images having the same subject in which the amount of exposure is substantially the same and the diaphragm sets each level from F4 to F32. FIGS. 5A to 5C illustrate embodiments of three images among seven images.

FIG. 5A illustrates an image photographed by photographing modes (contraction limit) corresponding to the dot SC 16 on the bold dotted line L16 in FIG. 4. FIG. 5B illustrates an image photographed by photographing modes corresponding to a dot SM 16 on the bold dotted line L16 in FIG. 4. FIG. 5C illustrates an image photographed by photographing modes (open limit) corresponding to a dot SO16 on the bold dotted line L16 in FIG. 4. An image which is photographed by contracting the aperture to the limit may be an image having a deep depth of field, for example, as shown in FIG. 5A, and may have a correct pint to a main subject F and a non-principal subject H disposed in the rear of the subject F. Meanwhile, an image which is photographed by opening the aperture to the limit may be an image having a shallow depth of field, for example, as shown in FIG. 5C, may have a correct pint in front of the main subject F, a side part of the subject F is a little vague, and the non-principal subject H may have a very vague image. In addition, an image which is photographed by set the aperture to a middle between the open limit and the contraction limit may be an image having a moderate depth of field, for example, as shown in FIG. 5B, the main subject F may have a correct pint as a whole. However, the rear non-principal subject H becomes vague.

In addition, when a subject having the appropriate exposure 10 EV is photographed, six photographing processes are continuously performed by using a photographing mode corresponding to six dots (black circle) on the bold dotted line L10 of FIG. 4. In addition, the shutter speed is fixed, the aperture and the ISO sensitivity are sequentially varied, and then three photographing processes are continuously performed by using a photographing mode corresponding to three points (square dot, triangle dot, dot having x-type) on the dotted line M10 of FIG. 4. As a result, the control unit 20 obtains nine images having the same subject in which the amount of exposure is substantially the same and the diaphragm is photographed by setting the each level from F1.4 to F22.

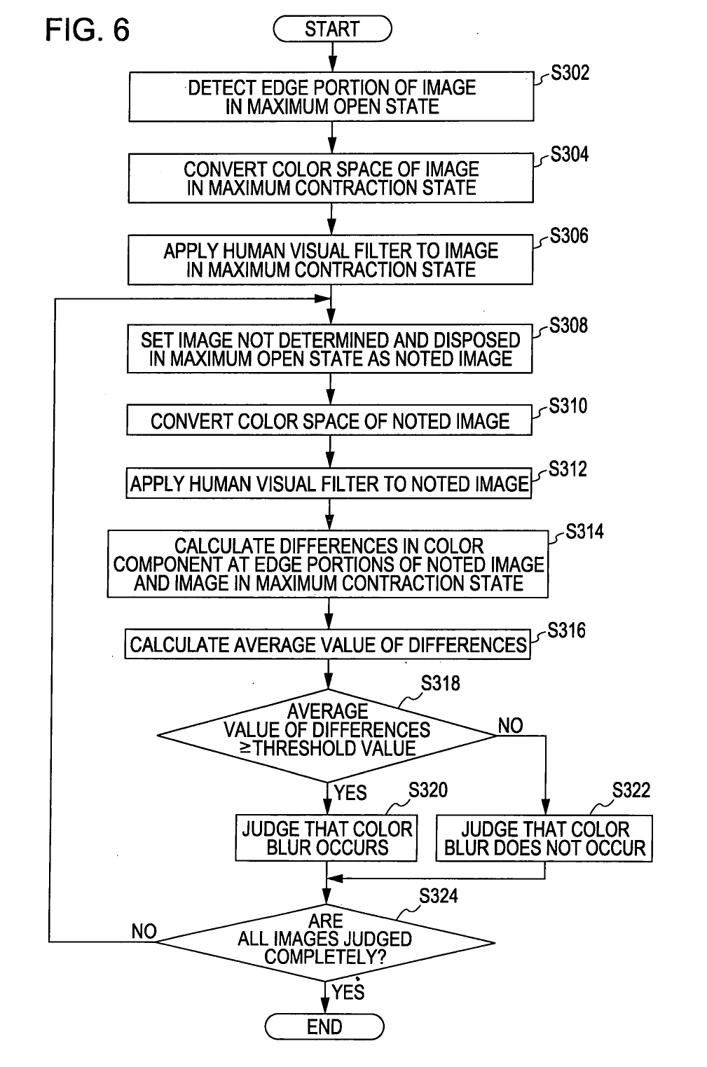

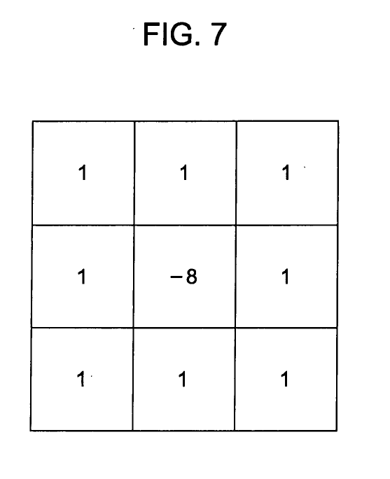

With reference to FIGS. 6 and 7, a color blur determining process (step s116) after photographing process will be described. FIG. 6 is a flow chart illustrating a process routine of the color blur determining process. FIG. 7 is an embodiment of a Laplacian filter which is used for detecting the edge.

The color blur determining process is performed by the image processing unit 25 of the control unit 20. When the color blur determining process is performed, the edge detecting unit 251 of the image processing unit 25 detects an edge portion of the images (open limit image) photographed by setting the aperture to the open limit among a plurality of images (continuous photographed images) photographed by the above-mentioned continuous photographed process (step s302). The edge portion is a part which has high differences of a gray-scale value between adjacent pixels shown in contour parts of the subject of the image. The edge detecting section 251, for example, detects an edge image in which the edge quantity is bigger than a predetermined critical value, and a part made of the edge image may be an edge portion. For example, the edge quantity of the pixel is calculated by applying eight neighborhood Laplacian filter as shown in FIG. 7 about the each pixel. Specifically, the edge detecting section 251 uses an absolute of sum values obtained by multiplying a set coefficient to the eight neighborhood Laplacian filter at an attention pixel and each luminance value of the eight adjacent eight pixels, respectively. The luminance value, for example, uses a luminance value Y in YCbCr color space and a brightness value L in L*a*b*color space. When the pixel data is disposed in the sRGB color space, the luminance value Y is calculated by Expression 1.
Y=0.29891×R+0.58661×G+0.11448×B (1)

In the focused-image, since contour parts of the object or the detail of the object are clearly described, the edge portion is increased. In the defocused area, since the contour parts of the object or the detail of the object become blurry, the edge portion is decreased. Accordingly, as the aperture narrows the image (high F number value), a focused-image part is increased. Accordingly, the edge portion is increased. As the aperture opens the image (low F number value), the defocused-image part is decreased. Accordingly, the edge portion is decreased. As a result, the edge portion of the open limit state (e.g. images of FIG. 5C) can be an edge portion to other images among the continuous photographed image. In step, to detect the edge portion is to detect the edge portion which is common to the continuous photographed images by using the open limit state images.

Next, the image processing unit 25 converts a color space of pixel data of an image (image of limit contraction value) photographed by setting the aperture to the contraction limit into an opposite color space among the continuous photographed images (step s304). The opposite color space is a space made of luminance component O₁, color difference component O₂ (red-green component), O₃ (blue-yellow component). Each component corresponds to three senses of a visual angle recognized by human brains. When the pixel data is disposed in the sRGB color space, each component (O₁, O₂, O₃) of the opposite color space is calculated through CIEXYZ color space by a following Expression 2 and 3.

$$\begin{matrix}Equation 1 & \\ ( \begin{matrix}X \\ Y \\ Z\end{matrix} ) = ( \begin{matrix}0.4361 & 0.3851 & 0.1931 \\ 0.2224 & 0.7169 & 0.0606 \\ 0.0139 & 0.0971 & 0.7141\end{matrix} ) ( \begin{matrix}R \\ G \\ B\end{matrix} ) & ( 2 ) \\ ( \begin{matrix}{O}_{1} \\ {O}_{2} \\ {O}_{3}\end{matrix} ) = ( \begin{matrix}0.279 & 0.72 & - 0.107 \\ 0.449 & 0.29 & - 0.077 \\ 0.086 & 0.59 & - 0.501\end{matrix} ) ( \begin{matrix}X \\ Y \\ Z\end{matrix} ) & ( 3 )\end{matrix}$$

The filter processing section 252 of the image processing unit 25 applies the human visual filter about the image of the contraction limit, which converts the image data into the opposite color space (step s306). The human visual filter is a filter that compares a spatial resolution of the luminance so as to convert each pixel data of the image recognizable value at the time of seeing the image by considering characteristics that a spatial resolution is largely low about the color difference. Each component value (Ot₁, Ot₂, Ot₃) of the pixel data after converting the data is calculated by a following Equations 4 to 6.

$$\begin{matrix}Equation 2 & \\ {Ot}_{j} ( x , y ) = {O}_{j} ( x , y ) * {f}^{j} ( x , y ) ; j = 1 , 2 , 3 & ( 4 ) \\ {f}^{j} ( x , y ) = {k}^{j} {\sum }_{i} {w}_{i}^{j} {E}_{i}^{j} ( x , y ) & ( 5 ) \\ {E}_{i}^{j} ( x , y ) = {k}_{i}^{j} exp ( \frac{- ( {x}^{2} + {y}^{2} )}{{( {σ}_{i}^{j} )}^{2}} ) & ( 6 )\end{matrix}$$

In the Equation, “*” denotes a convolution integral. In the Equation, “(x, y)” denotes a coordinate of the pixel in the image. In the Equation, kᵢ and kⱼ^{j} is a normalized coefficient, kᵢ is set to 1 which is sum of f^{j}, and kᵢ^{j} is set to 1 which is sum of Eᵢ^{j}. A parameter wᵢ^{j} and σᵢ^{j} in the Equation will be shown in a following Table.

TABLE 2

| | wᵢ^{j} | σᵢ^{j} |
|---|---|---|
| O₁ | 0.921 | 0.0283 |
| (i = 1, 2, 3) | 0.105 | 0.133 |
| | −0.108 | 4.336 |
| O₂ | 0.531 | 0.0392 |
| (i = 1, 2) | 0.330 | 0.494 |
| O₃ | 0.488 | 0.0536 |
| (i = 1, 2) | 0.371 | 0.386 |

Subsequently, the image processing unit 25, an image photographed by setting the aperture to the contraction limit state is set to an attention image among an image which is not determined whether a following color blur occurs (step s308). In the first state, the open limit state image is set to the attention image.

When the attention image is set, the image processing unit 25 converts the color space of the pixel data of the attention image into the opposite color space (step s310). In addition, the image processing unit 25 applies the human visual filter about the attention image in which the pixel data is converted into the opposite color space (step s312). A method of converting the color space and applying the human visual field is described in above mentioned.

Subsequently, the difference calculating section 253 of the image processing unit 25 calculates the difference of the color component at edge portion between the attention image and the image of the contraction limit state. Specifically, when coordinates of the edge pixel forming the detected edge portion is set to (xₙ, yₙ) (n=1, 2, 3 . . . ) in step s302, the difference calculating section 253 calculates the difference value ΔC (xₙ, yₙ) (n=1, 2, 3 . . . ) of the color component of the each pixel by using a following Expression 7.
ΔC(xₙ, yₙ)=[{Os₂(xₙ, yₙ)−Or₂(xₙ, yₙ)}²+{Os₃(xₙ, yₙ)−Or₃(xₙ, yₙ)}²]^{1/2} (7)

In Expression 7, Os₂(xₙ, yₙ) denotes a color component value O₂ of the pixel of the coordinates (xₙ, yₙ) in the attention image. Or₂(xₙ, yₙ) denotes a color component value O₂ of the pixel of the coordinates (xₙ, yₙ) in the limit contraction image. Similarly, Os₃(xₙ, yₙ) denotes a color component value O₃ of the pixel of the coordinates (xₙ, yₙ) in the attention image. Or₃(xₙ, yₙ) denotes a color component value O₃ of the pixel of the coordinates (xₙ, yₙ) in the limit contraction image.

The image processing unit 25 calculates an average value ΔCave of the differences (step s316). The average value ΔCave of the differences is an average value of the color component value of the differences value ΔC(xn, yn) about the above-mentioned each pixel.

When the average value ΔCave of the differences is calculated, the color blur determining section 254 of the image processing unit 25 compares the average value ΔCave of the differences with a predetermined threshold value (step s318).

When the average value ΔCave of the differences is the threshold value or more (step s318: YES), the color blur determining section 254 determines that the color blur occurs on the attention image (step s320). When the average value ΔCave of the differences is the threshold value or less (step s318: NO), the color blur determining section 254 determines that the color blur does not occur (step s322). Herein, since the color blur is easily emitted on the edge portion of the image, the color blue determining is performed by using the color component of the differences in the edge portion.

When the color blur determining is performed in the attention image, the image processing unit 25 performs the color blur determining process about all the images other than the image of the limit contraction state among the continuous photographed images (step s324). When the images are not completely judged (step s324: NO), referring back to step S308, a new attention image is set. When the images are completely judged (step s324: YES), the color blur determining process ends.

Referring back to FIG. 2, an explanation will be keep going. When the color blur determining process ends, the image recording unit 24 makes an image file of which the color blur occurring is detected among the continuous photographed images, thereby storing the file to the external memory device 60 (step s118). Meanwhile, the image recording unit 24 deletes the image which is determined to have the color blur (step s118) among the continuous photographed images.

In the embodiment, according to the digital camera 100, a plurality of images having substantially the same brightness and different depth of fields is easily photographed by pressing the shutter button 41. As a result, the user obtains easily the images including the variable depth of field without cumbersome manipulation or knowledge for setting the photographing mode.

In addition, since the photographing mode is set in the range that degradation of the photo generated by motion blur does not occur, it is prevented that the image with motion blur is inserted to the continuous photographed images.

In addition, since the shutter speed and the sensitivity of the image sensor 14 (ISO sensitivity) are varied so as to maintain constantly a brightness of the image in accordance with a gradually variation, the depth of field is greatly changed.

In addition, since the photographing process is performed with all the photographing modes which can be set within the allowable setting range without the motion blur, the user obtains easily the image having a variable depth of field.

In addition, since the image having the color blue among the continuously photographed image is automatically deleted, it is prevented that the image in which the color blurs is inserted to the continuous photographed images owned by the user.

In addition, the color blur determining process is performed by comparing the color component of differences in the common edge portion to the continuous photographed images. Since the color blue is detected by focusing to the edge portion in which the color blur occurs easily, the color blur determining process is performed with high precision. In addition, since the edge detecting process about the attention image does not have to be performed, a processing load of the color blur determining process and a processing time is reduced.

In addition, since the color blur determining process is performed by using the pixel data which is made after applying the human visual filter, the color blur determining process is performed so as to increase the high precision by considering the characteristic of the human visual filter.

### B. Second Embodiment

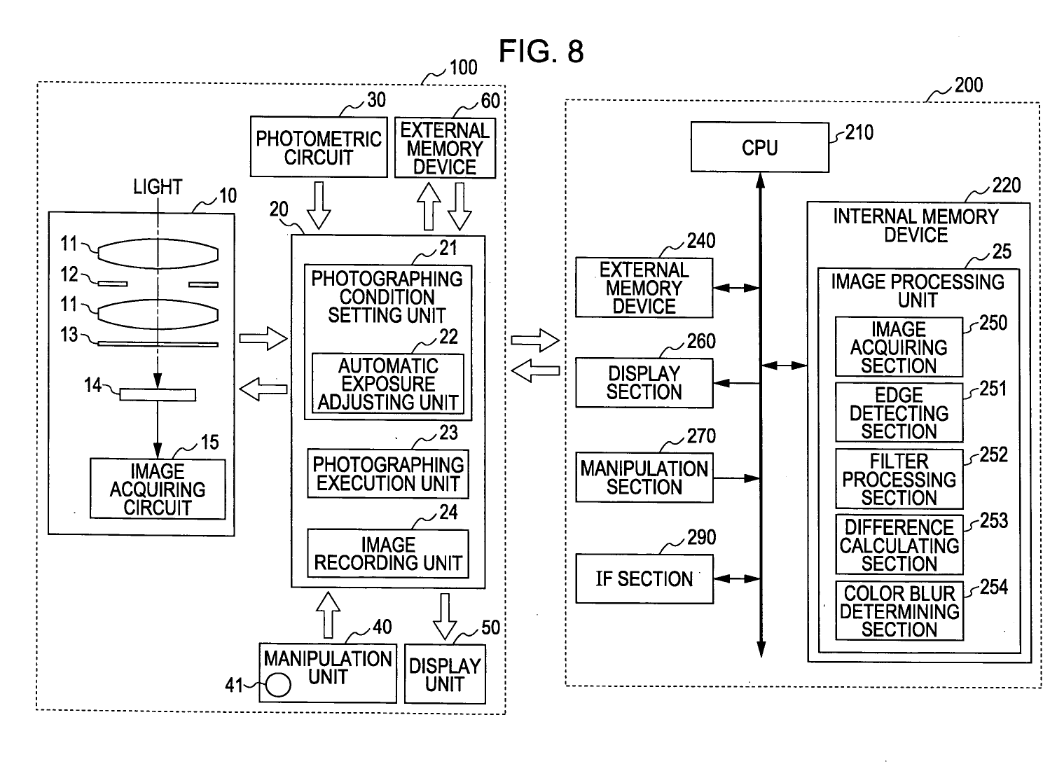

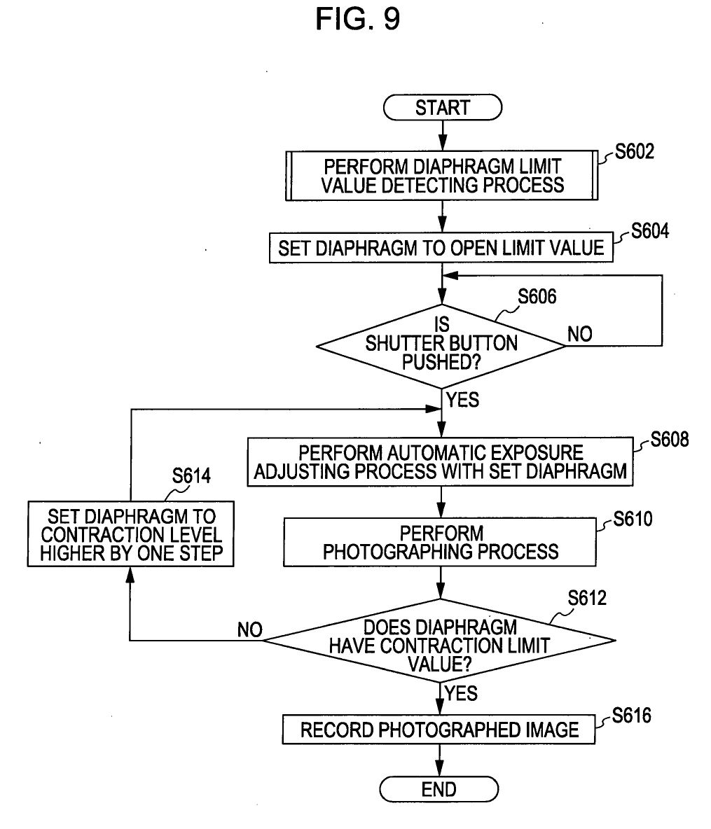

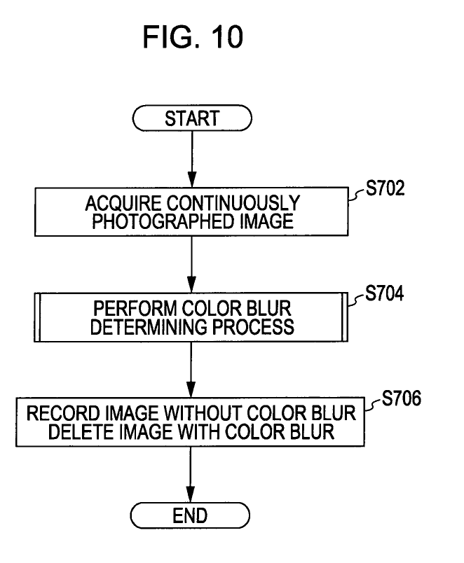

In the first embodiment, the color blur determining process is performed in the digital camera 100, but it is not limited to the digital camera. For example, the image processing unit 25 performing the color blur determining process may be mounted to a personal computer or to a print device such as an inkjet printer. With reference to FIGS. 8 to 10, an embodiment mounting the image processing unit 25 which performs the color blur determining process to a personal computer will be explained as a second embodiment. FIG. 8 is a schematic flowchart of the second embodiment. FIG. 9 is a flowchart illustrating an operation of the digital camera according to the second embodiment. FIG. 10 is a flow chart illustrating an operation of a personal computer according to the second embodiment.

System Configuration

A system of the second embodiment includes a digital camera 100b and a personal computer 200. In the second embodiment, the control unit 20 of the digital camera 100b does not include the image processing unit 25 so as to performing the color blue determining process other than the first embodiment (FIG. 1). Since the other configuration of the digital camera 100b according to the second embodiment is similar to the configuration of the digital camera 100 (FIG. 1) according to the first embodiment, parts having the same functions as those of FIG. 1 are represented by the same reference numbers and the descriptions thereof will be omitted.

In the second embodiment, the personal computer 200 includes a CPU 210, an internal memory device 220 such as ROM and RAM, an external memory device 240 such as a hard disk, a display section 260, a manipulation section 270 such as a mouse or a keyboard, and an interface section (I/F section) 290. The I/F section performs data communication between various devices provided outside. For example, the I/F section 290 obtains the image data from the digital camera 100b.

In the internal memory device 220, a computer program which is functioned as the image processing unit 250 is stored. The function of the image processing unit 230 is realized that the CPU 210 executes the computer program. The computer program, for example, is provided with a recorded type such as CD-ROM to a recording medium to be read by the computer.

The image processing unit 250 includes an image acquiring section 2501, an edge detecting section 2502, a filter processing section 2503, a difference calculating section 2504, and a color blur determining section 2505. The image acquiring section 2501 obtains continuous photographed images which are photographed by the digital camera 100b. Since the edge detecting section 2502, the filter processing section 2503, the difference calculating section 2054, and the color blur determining section 2505 are similar to the configuration of the first embodiment, the descriptions thereof will be omitted.

Operation of Digital Camera 100b

In the operation of the digital camera 100b shown in FIG. 9, since the step from step s602 to step s614 are similar to the operation explained in FIG. 2 of the digital camera 100 according to the first embodiment, the descriptions thereof will be omitted. The function unit performing the color blur determining process is not provided in the digital camera 100b according to the second embodiment. Accordingly, when the continuous photographed process ends (step s612: YES), the image recording unit 24 records all the continuous photographed images to the external memory device 60 (step s616) and terminates the process.

In the digital camera 100b, the continuous photographed images, for example, through the I/F section 290, are stored to the external memory device 240 of the personal computer 200.

Operation of Personal Computer 200

Subsequently, with reference to FIG. 10, an operation of the image processing section 250 of the personal computer 200 will be described. When the process of the image processing unit 250 is performed, the image acquiring unit 2501 of the image processing unit 250 obtains a continuous photographed images from the external memory device 240 (step s702). The image processing unit 250 performs the color blur determining process about the obtained continuous photographed images (step s704). Since contents of the color blur determining process of step is similar to the color blur determining process (FIG. 2: step s116) explained in the first embodiment, the descriptions thereof will be omitted. When the color blur determining process ends, the image processing unit 250 stores the images which is determined to have no color blur among the continuous photographed images, similarly to step s118 (FIG. 2) of the first embodiment, and deletes the images which is determined to have the color blur (step s706).

According to the system of the above-mentioned second embodiment, the same operation and effect are realized with the digital camera 100 in the first embodiment.

### C. Modified Example

The operation of the digital camera 100 in the bracket mode of the depth of field is not limited to the above-mentioned embodiment. As a following first modified example and a second modified example, another embodiment of an operation of the digital camera 100 will be described in a bracket mode of a depth of field.

### First Modified Example

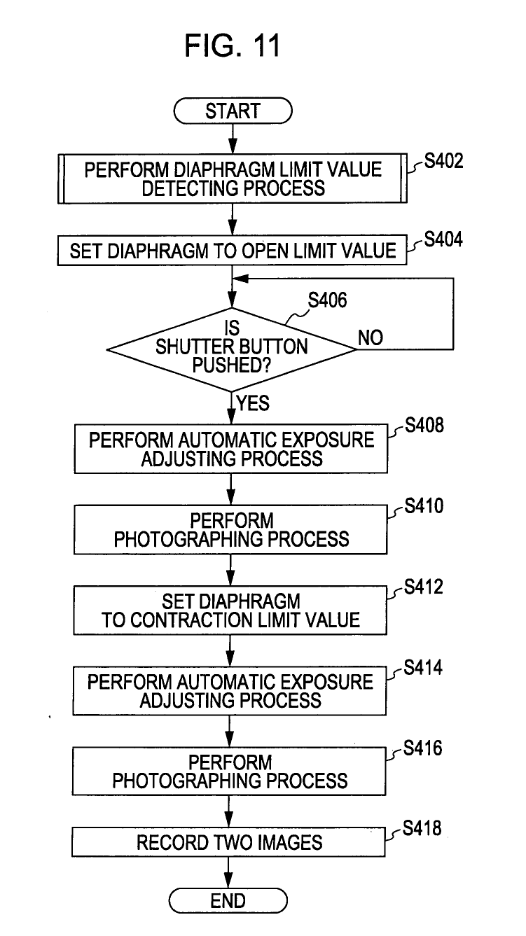

With reference to FIG. 11, an operation of the digital camera 100 according to a first modified example will be described. FIG. 11 is a flow chart illustrating the operation of the digital camera 100 according to the modified example. Since steps s402 to s406 of the modified example are similar to steps s102 to s106 (FIG. 2) of the first example, the descriptions thereof will be omitted. In step s406, when the user pushes the shutter button 41 so as to input the photographing instruction (step s106: YES), the automatic exposure adjusting unit 22 performs the automatic exposure adjusting process by using the aperture which is set to the open limit state (step s408). Accordingly, ISO sensitivity and the shutter speed are determined so that the aperture is set to the open limit. When the automatic exposure adjusting ends, the photographing execution unit 23 performs the photographing process to the photographing unit 10 in accordance with the determined photographing modes (aperture, ISO sensitivity, shutter speed) (step s410).

When the photographing process ends by setting the aperture to the open limit, the photographing mode setting unit 21 sets the aperture to the contraction limit (step s412). Subsequently, the automatic exposure adjusting unit 22 performs the automatic exposure adjusting process by setting the aperture to the contraction limit (step s414). Accordingly, the ISO sensitivity and the shutter speed are determined so that an appropriate exposure is obtained by setting the aperture to the contraction limit. When the automatic exposure adjusting ends, the photographing execution unit 23 performs (step s416) the photographing process to the photographing unit 10 by the determined photographing modes (aperture, ISO sensitivity, shutter speed).

The image recording unit 24 of the control unit 20 records the image which is photographed by setting the aperture to the open limit and the image which is photographed by setting the aperture to the contraction limit, respectively, as image files to the external memory device 60 (step s418), thereby terminating the process.

According to the first modified example, the camera 100 acquires an images having a deep depth of field and an images having a shallow depth of field among the photographed images by one manipulation. For example, when an object having the appropriate amount of exposure of 10 EV is photographed, an image by the condition corresponding to the dot SO10 of FIG. 4 and an image by the condition corresponding to the dot SC 10 of FIG. 4 are obtained. As a result, the user uses easily the photographing technology which varies the depth of field.

In the modified example, since the color blur determining process is not performed, the digital camera performing only the operation of the modified example among the configuration shown in FIG. 1 does not have to posses the function sections 251 to 254.

### Second Modified Example

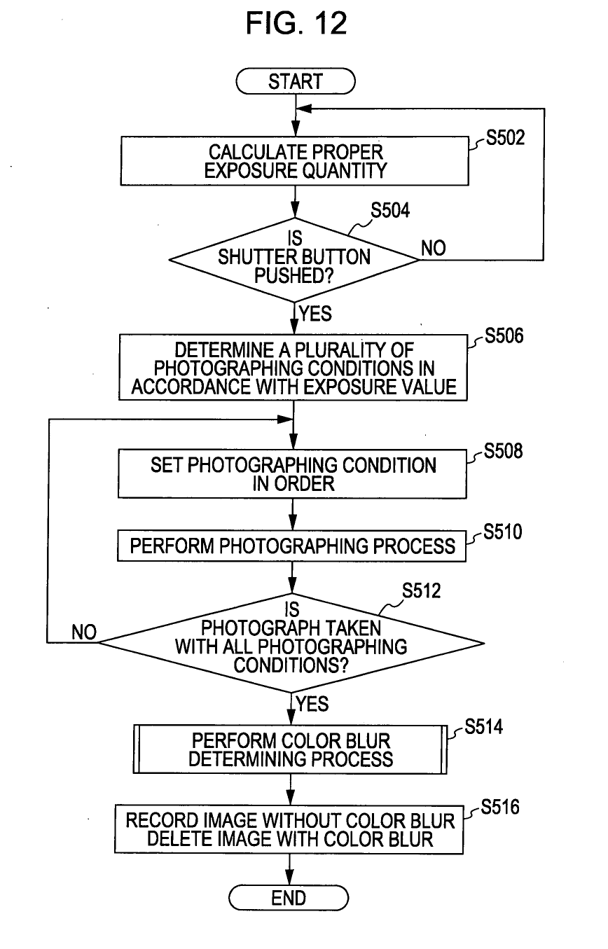

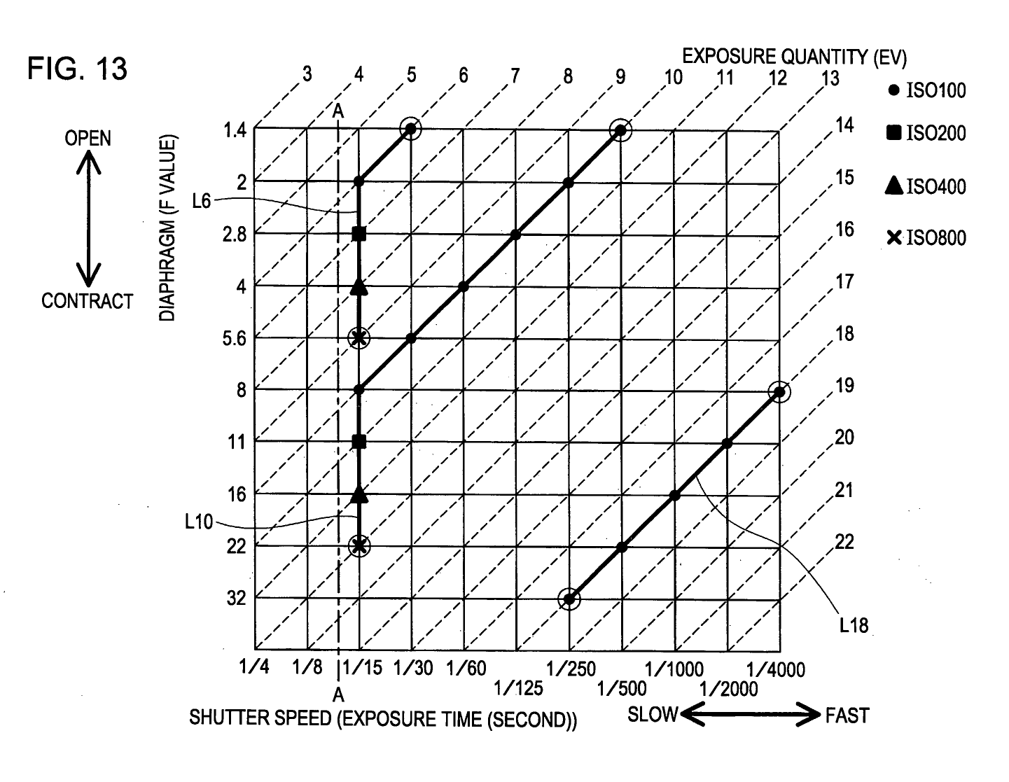

With reference to FIGS. 12 to 13, an operation of the digital camera 100 according to a second modified example will be described. FIG. 12 is a flow chart illustrating the operation of the digital camera 100 according to the modified example. FIG. 13 is a program line diagram illustrating photographing modes stored in the photographing mode setting unit 21.

In the digital camera 100 according to the second modified example, a plurality of photographing modes including a variable aperture are programmed to the photographing mode setting unit 21 at the appropriate amount of exposure. When the photographing mode setting unit 21 recognizes the appropriate amount of the exposure, the plurality of photographing mode are determined according to the program. Hereinafter, the above-mentioned example will be described in detail.

When the bracket mode of the depth of field is selected, the photographing mode setting unit 21 measures a brightness of the subject so as to calculate the appropriate amount of the exposure in accordance with the brightness of the subject by using the photometric circuit 30 (step s502). For example, the calculation of the amount of the exposure may be performed, when the user pushes the shutter button 41 so as to be in a half-pushed state. In addition, the calculation of the amount of the exposure may be performed again about the subject captured by the digital camera 100 and waits for pushing the shutter button 41.

When the user pushes the shutter button 41 so as to input the photographing instruction (step s504: YES), the photographing mode setting unit 21 determines a plurality of photographing modes programmed in advance in accordance with the proper amount of exposure (step s506). As shown in the program line diagram of FIG. 13, for example, when the proper amount of the exposure about the brightness of the subject is 6 EV, five photographing modes corresponding to five dots on a bold line L6 are determined. In addition, when the proper amount of the exposure about the brightness of the subject is 18 EV, five photographing modes corresponding to five dots on a bold line L18 are determined. In the photographing mode setting unit 21 about all the allowable amount of the exposure, the plurality of photographing modes are programmed. However, so as to prevent complication of the figure in the program line diagram of FIG. 13, the proper amount of the exposure are denoted having the photographing modes of 6 EV, 10 EV, and 18 EV. As shown in FIG. 13, the plurality of photographing modes are set in the range without the motion blur, similarly to the example, and the aperture is varied in the large range by varying the shutter speed and the ISO sensitivity.

When a plurality of photographing modes is determined, the photographing mode setting unit 21 sets sequentially the plurality of photographing modes (step s508). When the photographing mode is set, the photographing execution unit 23 performs the photographing process to the photographing unit 10 by the photographing mode. Next, the photographing process about the determined plurality of setting conditions in the above-mentioned step s506 is determined to end (step s512). Steps s508 and s510 are performed again and again until all the photographing modes are photographed. When all the photographing modes are photographed (step s512: YES), step s514 is performed.

Since steps s514 and s516 are similar to steps s116 and s118 (FIG. 2) in the first example, the description thereof will be omitted.

According to the modified example, the operation effect similar to the example will be realized. According to the modified example, the plurality of photographing modes which use in advance the bracket mode of the depth of field in accordance with the amount of the exposure are programmed. The plurality of photographing modes are easily determined by determining the proper amount of the exposure without performing the aperture limit detecting process according to the example.

### Third Modified Example

In the example, an image which is determined to have no color blur after performing the color blur determining process is deleted (step s118: FIG. 2). Alternatively, the image recording unit 24, after performing the color blur determining process, may stores information showing whether the color blur occurs, in relation to the each image as the image file. The information showing whether the color blur occurs, for example, is stored in a storage area of attached information about the image file. For example, in the storage area of the attached information about the image file having the file structure in accordance with Exif standard, Makernote area which the manufacturer of the digital camera uses freely is defined. The information showing whether the color blur occurs, for example, is stored in the Markernote area.

According to the third modified example, the information showing whether the color blur occurs to a plurality of images photographed by the bracket mode of the depth of field, respectively. As a result, the user obtaining the image or the image processing device of the personal computer recognizes easily whether the color blur occurs about the images. For example, when the user selects the images to be printed or the images to be stored, the user refer to the information showing whether the color blur occurs.

### Fourth Modified Example

In the example, the image recording unit 24 records all the images which are determined to have no color blur as the image file, but the image recording unit 24 may record selectively a part of the image which is determined to have no color blur as the image file. For example, the image recording unit 24 stores only the two images photographed using the photographing mode in which the aperture is opened to the maximum extent possible out of the limit contraction image and the image which is determined to have no color blur.

### Fifth Modified Example

In the example, eight neighborhood Laplacian filter is used for calculating the edge quantity. Alternatively, four neighborhood Laplacian filter, Prewitt filter, or Sobel filter may be used for calculating a gray-scale value at the position of the attention image. In addition, “maximum luminance value-minimum luminance value” may be used for edge quantity at the attention image and in the vicinity of the image. The range comparing the luminance value is used as a rectangular range such as 3×3 pixel range or 5×5 pixel range. In addition, other types of range may be used.

In addition, the color blur may not be limited to the luminance value Y, but may vary at a portion in which various color components vary substantially. Accordingly, the edge quantity may be an indicator which shows a size of a gray-scale of various color components at the attention position (e.g. each color component of RGB or each color component of YCbCr). For example, the calculated value is used as the edge quantity by using the filter at G component of RGB color component, or a sum value of the calculated each edge quantity may be used as the edge quantity at each RGB color component.

### Sixth Modified Example

In the example, the calculation of the color component value ΔC is calculated by using the color component (O2, O3) at the opposite color space (O1, O2, O3), but it is not limited to this. For example, the calculation of the color component value ΔC may be calculated by using the color component (a*, b*) at CIEL*a*b*color space, or may be calculated by using the color component (Cb, Cr) at YCbCr color space.

In addition, in the example, the detection of the color blur determining process is performed by using the average value of the color component difference value ΔC, but it is not limited to this. For example, the color blur determining section 254 may detect that the color blur occur, when an edge pixel exists in a state where the color component difference value ΔC is more than a predetermined value.

### Seventh Modified Example

In the example, the detection of the color blur determining process is performed by using the pixel value after applying the human visual filter, but the applying the human visual filter may be omitted. However, when the human visual filter is applied, the color blur determining process is easily detected with high precision by considering the characteristic of the human visual filter

### Eighth Modified Example

In the example, the detection of the edge portion is performed by using the image at the limit open state. In addition, the edge portion at the limit open state is used for detecting the color blur determining process as the common edge portion to the continuous photographing images. Alternatively, the edge portion corresponding to each attention image which is an object of the color blur determining process may be performed. In addition, the color blur determining process may be performed by using the detected edge portion of the attention images about the attention images. When the edge detection is performed by using the image at the limit open state, the edge detection process ends at one time. Accordingly, the processing time and the processing load may be reduced at the color blur determining process.

### Ninth Modified Example

In the example, the color blur determining process calculates the color component difference value ΔC between the attention image and the limit contraction image on the basis of the limit contraction image. Since the limit contraction image does not have the color blur in general, the image is determined to have no color blur. When the image is determined to have no color blur, the standard image may not be the limit contraction image. For example, when the photographed image using a photographing mode in which the aperture is contracted with second level from the characteristic of the digital camera 100, the image is determined to have no color blur. Accordingly, the above-mentioned image is a standard image.

### Tenth Modified Example

In the example, a part of the configuration embodied by hardware may be moved to software. On the contrary, a part of the configuration embodied by the software may be moved to the hardware. For example, the filter processing section 252 or the edge detecting section 251 are embodied in an exclusive hardware among a part of each function of the image processing unit 25 as a substitute for the software.

### Eleventh Modified Example

In the example, the digital camera is described as an example. However, the device which is continuously photographed using a plurality of photographing modes including substantially the same amount of exposure and the different aperture may be performed to a silver-salt camera. At this time, the user obtains easily a plurality of silver-salt photos having a variable depth of field.

In addition, the invention is described with reference to examples and modified examples. The embodiment of the invention has been illustrated to help easy understanding of the invention, but the invention is not limited to that various changes and modifications can be made without departing the spirit and claims of the invention, and equivalents thereof is also included in the invention.

The disclosure of Japanese Patent Application No. 2006-78988 filed Nov. Mar. 22, 2006 including specification, drawings and claims is incorporated herein by reference in its entirety.

What is claimed is:

1. An imaging device comprising:
a photographing instruction input unit configured to enable inputting of a photographing instruction;
a mode setting unit which sets a plurality of photographing modes having substantially the same amount of exposure and different apertures; and
a photographing unit which successively performs photographing processes using the plurality of photographing modes in response to a single photographing instruction.

2. The imaging device according to claim 1 further comprising an automatic exposure adjusting unit,
wherein an allowable setting range of apertures in the plurality of photographing modes is a range where an appropriate amount of exposure can be set by the automatic exposure adjusting unit.

3. The imaging device according to claim 2, wherein the allowable setting range of apertures in the plurality of photographing modes is a range where the proper amount of exposure can be set with a shutter speed in which blur does not occur.

4. The imaging device according to claim 2, wherein the plurality of photographing modes include a first photographing mode in which the aperture is set to an open limit of the allowable setting range and a second photographing mode in which the aperture is be set to a contraction limit of the allowable setting range.

5. The imaging device according to claim 2, wherein the plurality of photographing modes include all the photographing modes which can be set within the allowable setting range.

6. The imaging device according to claim 1, further comprising an image sensor, the sensitivity of which can be varied by a plurality of levels,
wherein the plurality of photographing modes include a plurality of photographing modes having substantially the same amount of exposure with the various sensitivity levels of the image sensor.

7. The imaging device according to claim 1 further comprising:
an edge detecting section which detects an edge portion of a first image among a plurality of images photographed using the plurality of photographing modes;
a difference calculating section which calculates difference between color components of the edge portion of the first image and color components of the edge portion of a second image photographed using the photographing mode in which the aperture is narrower than that of the first image among the plurality of images; and
a determining section which determines whether color blur occurs in the first image on the basis of the differences.

8. The imaging device according to claim 7, wherein the detection of the edge portion of the first image is performed by detecting an edge portion which is common to the plurality of images.

9. The imaging device according to claim 8, wherein the edge portion which is common to the plurality of images is an edge portion of an image photographed using a photographing mode in which the aperture is opened to the maximum extent possible among the plurality of images.

10. The imaging device according to claim 7, wherein the second image is an image photographed using the photographing mode in which the aperture is narrowed to the maximum extent possible.

11. The imaging device according to claim 7 further comprising a filter processing section which performs a filtering process in which a human visual filter is applied to the edge portions of the first image and the second image,
wherein the difference calculating section calculates the differences between the edge portions having been subjected to the filtering process.

12. The imaging device according to claim 7, wherein the first image which is determined to have color blur is deleted.

13. The imaging device according to claim 7, wherein information indicating an occurrence of color blur is correlated with the first image which is determined to have color blur.

14. The imaging device according to claim 10, wherein only the image photographed using the photographing mode in which the aperture is opened to the maximum extent possible is stored among the second image and the first image which is determined to have no color blur.

15. A program product allowing a computer to control an imaging device, the computer program allowing the computer to perform the functions of:
setting a plurality of photographing modes having a substantially the same amount of exposure and different apertures; and
allowing the imaging device to successively perform photographing processes using the plurality of photographing modes in response to a single photographing instruction.

16. A method of acquiring a plurality of images, the method comprising:
setting a plurality of photographing modes having substantially the same amount of exposure and different apertures;
successively performing photographing processes using the plurality of photographing modes in response to a single photographing instruction;
detecting an edge portion of a first image among a plurality of images photographed using the plurality of photographing modes;
calculating differences between color components of the edge portion of the first image and color components of the edge portion of a second image photographed using the photographing mode in which an aperture is narrowed more than that of the first image, and
determining whether color blur occurs in the first image on the basis of the differences.
